(19) United States
(12) Patent Application Publication
(10) Pub. No.: US 2005/0122498 A1
(43) Pub. Date: Jun. 9, 2005

(54) Lithographic apparatus and device manufacturing method

(75) Inventor: Johannes Christiaan Maria Jasper, Veldhoven (NL)

Correspondence Address: PILLSBURY WINTHROP SHAW PITTMAN, LLP, P.O. BOX 10500, MCLEAN, VA, 22102, US

(73) Assignee: ASML NETHERLANDS B.V., Veldhoven (NL)

(21) Appl. No.: 10/976,313

(22) Filed: Oct. 29, 2004

(30) Foreign Application Priority Data
Oct. 30, 2003 (EP) 03256893.3

(51) Int. Cl. G03B 27/42

(52) U.S. Cl. 355/53

(57) ABSTRACT

A lithographic apparatus is provided that includes a purging device for purging a part of the apparatus with a purge gas. The purging device is operable in a first mode having a relatively high flow of purge gas and a second mode having a relatively low flow of purge gas. A controller that is constructed and arranged to control an intensity of the beam of radiation, so that the intensity of the beam of radiation can be made lower than a normal intensity in response to a change in mode of a purging device from the second mode to the first mode. The controller is arranged to monitor the downstream intensity of the beam of radiation as measured by a sensor and to prevent generation of radiation at the normal intensity until the downstream intensity of the beam of radiation meets a predetermined criterion.

### CROSS-REFERENCE TO RELATED APPLICATIONS

This application claims the benefit of priority from European Patent Application No. 3256893.3, filed Oct. 30, 2003, the entire content of which is incorporated herein by reference.

### FIELD

The present invention relates to a lithographic apparatus and a device manufacturing method.

### BACKGROUND

A lithographic apparatus is a machine that applies a desired pattern onto a target portion of a substrate. Lithographic apparatus can be used, for example, in the manufacture of integrated circuits (ICs). In that circumstance, a patterning device, such as a mask, may be used to generate a circuit pattern corresponding to an individual layer of the IC, and this pattern can be imaged onto a target portion (e.g. including part of, one or several dies) on a substrate (e.g. a silicon wafer) that has a layer of radiation-sensitive material (resist). In general, a single substrate will contain a network of adjacent target portions that are successively exposed. Known lithographic apparatus include so-called steppers, in which each target portion is irradiated by exposing an entire pattern onto the target portion in one go, and so-called scanners, in which each target portion is irradiated by scanning the pattern through the projection beam in a given direction (the “scanning”-direction) while synchronously scanning the substrate parallel or anti-parallel to this direction.

In a lithographic apparatus, the size of features that can be imaged is limited by the wavelength of the exposure radiation used. Therefore, to be able to image finer details, it is necessary to use radiation of shorter wavelength. Current production lithographic apparatus use ultraviolet radiation with wavelengths of 248 nm or 193 nm. Apparatus using radiation at 157 nm are under development. One of the challenges of a lithographic apparatus suing 157 nm radiation is that ordinary atmospheric air is substantially opaque at that wavelength. Therefore, it is proposed to purge the lithographic apparatus, or at least the beam path, with extremely pure nitrogen (N₂). The degree of purity needed may be very high, and even a few parts per million (ppm) of oxygen or water vapor may cause a significant reduction in the transmission of the exposure radiation. Use of such high purity nitrogen presents two problems—it is expensive and it is hazardous to the personnel operating or servicing the apparatus.

To alleviate these problems, it has been proposed that the purge system have two modes, a high-flow mode for exposures and a low-flow mode for use when the apparatus is not in use and particularly when a compartment of the apparatus has been opened, e.g. for servicing. The low-flow mode has a flow rate that is just sufficient to protect the optical elements in the apparatus from contamination that might occur on exposure to the normal atmosphere, but is not hazardous to humans. When the apparatus is to be restarted after a period in low-flow purge mode, it takes some time, in the order of 15-30 minutes in high-flow purge mode to purge the beam path so that production can recommence. This time helps to ensure a uniform gas mixture in the beam path and, hence, a uniform dose across the exposure field. Because optical elements in the apparatus may be damaged if the exposure radiation source is turned on while contaminants are present, and known O₂ and water sensors cannot reliably detect the levels of contamination that might causes damage, there may be a delay of as much as 30-60 mins each time a compartment of the apparatus is opened before production may recommence. Such downtime seriously reduces the throughput of the apparatus.

### SUMMARY

It is an aspect of the present invention to provide a lithographic apparatus and device manufacturing method in which production may be recommenced more quickly after a period of less than full flow purging.

According to an embodiment of the invention, there is provided a lithographic apparatus that includes an illumination system for providing a beam of radiation, and a support structure for supporting a patterning device. The patterning device serves to impart the beam of radiation with a pattern in its cross-section. The apparatus also includes a substrate table for holding a substrate, a projection system for projecting the patterned beam onto a target portion of the substrate, and a purging device for purging at least a part of the apparatus with a purge gas. The purging device is operable in a first mode having a relatively high flow of purge gas, and a second mode having a relatively low flow of purge gas. The apparatus further includes a sensor for measuring, the intensity of the beam of radiation at a position downstream, with respect to the direction of the beam of radiation, of the part of the apparatus, and a control device that is arranged to control the illumination system to generate a beam of radiation at an intensity lower than a normal intensity used to expose target portions of the substrate in response to a change in mode of the purging device from the second mode to the first mode, and arranged to monitor the intensity of the beam of radiation as measured by the sensor. The control device is arranged to prevent the illumination system from generating a beam of radiation having the normal intensity until the intensity of the beam of radiation as measured by the sensor meets a predetermined criterion.

In an embodiment of the invention, a lithographic apparatus is provided. The lithographic apparatus includes an illumination system for transmitting a beam of radiation, and a support for supporting a patterning device. The patterning device serves to impart the beam of radiation with a pattern in its cross-section. The apparatus also includes a substrate table for holding a substrate, a projection system for projecting the patterned beam of radiation onto a target portion of the substrate, and a purging device for purging a part of the apparatus with a purge gas. The purging device is operable in a first mode that has a relatively high flow of purge gas and a second mode that has a relatively low flow of purge gas. The apparatus further includes a sensor for measuring the intensity of the beam of radiation at a position downstream, with respect to the direction of the beam of radiation, of the part of the apparatus that is purged, and a controller that is constructed and arranged to control an intensity of the beam of radiation, so that the intensity of the beam of radiation can be made lower than a normal intensity in response to a change in mode of the purging device from the second mode to the first mode. The controller is arranged to monitor the downstream intensity of the beam of radiation as measured by the sensor and to prevent generation of radiation at the normal intensity until the downstream intensity of the beam of radiation meets a predetermined criterion.

By using a sensor to monitor the intensity of the beam of radiation downstream, with respect to the direction of the beam, of the purged compartment, a highly sensitive contamination detector may be effected, thereby enabling the apparatus to return to production mode as soon as contamination levels have returned to specification for production. At the same time, using only a low intensity prevents damage to the optical elements of the apparatus in the presence of contaminants.

The predetermined criterion may be that the intensity of the beam has reached a level indicative that the transmission of the beam path has returned to the level that should be used for production, e.g. 99% or higher transmission. During the low-flow, second purge mode, the transmission of the beam path may be about 60% of the transmission during high-flow purging and after contaminants have been cleared.

In an embodiment of the invention, the predetermined criterion is that the variation in transmission of the beam path is less than a predetermined threshold, e.g. 1%. When the transmission is that stable, it can be assumed that the purge conditions are that stable. This arrangement avoids the need to provide a sensor with a high absolute accuracy over a long period of time, which may be needed if intensity levels before and after a downtime period are to be compared.

The energy sensor may be spatially sensitive, and the predetermined criterion may be that the beam intensity across at least a part of its cross-section has a predetermined uniformity. By considering the uniformity of the beam intensity rather than its absolute intensity, any variations in its intensity caused by fluctuations in source output may be disregarded.

Where the beam of radiation is pulsed, the predetermined criterion may refer to a measurement averaged over several pulses. Again, pulse-to-pulse variations in source output may be disregarded.

The intensity of the beam may be reduced by operating a pulsed radiation source at a lower pulse repetition rate, e.g. 1 Hz, than that used during production, e.g. 4 kHz, and/or by using a variable attenuator in the illumination system.

According to a further embodiment of the invention, there is provided a device manufacturing method that includes purging a part of the beam path traversed by a beam of radiation with a purge gas at a first flow rate, purging the part of the beam path traversed by the beam of radiation with a purge gas at a second flow rate that is higher than the first flow rate, directing a beam of radiation at a first intensity along the beam path during purging at the second flow rate, monitoring a transmission of the part of the beam path, and directing a beam of radiation at a second intensity higher than the first intensity along the beam path to expose a target portion of a substrate, after the transmission of the beam path meets a predetermined criterion.

In an embodiment of the invention, a device manufacturing method is provided. The device manufacturing method includes purging a part of a beam path traversed by a beam of radiation with a purge gas at a first flow rate, purging the part of the beam path with a purge gas at a second flow rate that is higher than the first flow rate, directing a beam of radiation at a first intensity along the beam path during the purging with the purge gas at the second flow rate, monitoring a transmission of the part of the beam path, directing a beam of radiation at a second intensity that is higher than said first intensity along said beam path, after the transmission of said beam path meets a predetermined criterion, patterning the beam of radiation at the second intensity, and projecting the patterned beam of radiation onto a target portion of a substrate. A device that is manufacturing according to this method may also be provided.

In an embodiment a device manufacturing method for a lithographic apparatus is provided. The method includes patterning a beam of radiation, projecting the patterned beam of radiation onto a target portion of a substrate, and purging a part of the apparatus with a purging device. The purging device is operable in a first mode having a relatively high flow of purge gas and a second mode having a relatively low flow of purge gas. The method also includes measuring the intensity of the beam of radiation at a position downstream, with respect to the direction of the beam of radiation, of the part of the apparatus that is purged, with a sensor, and controlling an intensity of the beam of radiation, so that the intensity of the beam of radiation can be made lower than a normal intensity in response to a change in mode of the purging device from the second mode to the first mode, the controller being arranged to monitor the downstream intensity of the beam of radiation as measured by the sensor and to prevent generation of radiation at the normal intensity until the downstream intensity of the beam of radiation meets a predetermined criterion.

In an embodiment, in a lithography apparatus using 157 nm radiation, after a low-flow purge mode has been used, the projection beam is activated at a low intensity and the intensity at substrate level is monitored. When the intensity at substrate level is indicative that the transmission on the beam path is back to normal, it is determined that it is safe to recommence exposures.

Although specific reference may be made in this text to the use of lithographic apparatus in the manufacture of ICs, it should be understood that the lithographic apparatus described herein may have other applications, such as the manufacture of integrated optical systems, guidance and detection patterns for magnetic domain memories, liquid-crystal displays (LCDs), thin-film magnetic heads, etc. The skilled artisan will appreciate that, in the context of such alternative applications, any use of the terms “wafer” or “die” herein may be considered as synonymous with the more general terms “substrate” or “target portion”, respectively. The substrate referred to herein may be processed, before or after exposure, in for example, a track (a tool that typically applies a layer of resist to a substrate and develops the exposed resist) or a metrology or inspection tool. Where applicable, the disclosure herein may be applied to such and other substrate processing tools. Further, the substrate may be processed more than once, for example, in order to create a multi-layer IC, so that the term substrate used herein may also refer to a substrate that already contains multiple processed layers.

The terms “radiation” and “beam” as used herein encompass all types of electromagnetic radiation, including ultraviolet (UV) radiation (e.g. having a wavelength of 365, 248, 193, 157 or 126 nm) and extreme ultra-violet (EUV) radiation (e.g. having a wavelength in the range of 5-20 nm), as well as particle beams, such as ion beams or electron beams.

The term “patterning device” as used herein should be broadly interpreted as referring to a device that can be used to impart a projection beam with a pattern in its cross-section such as to create a pattern in a target portion of the substrate. It should be noted that the pattern imparted to the projection beam may not exactly correspond to the desired pattern in the target portion of the substrate. Generally, the pattern imparted to the projection beam will correspond to a particular functional layer in a device being created in the target portion, such as an integrated circuit.

The patterning device may be transmissive or reflective. Examples of patterning devices include masks, programmable mirror arrays, and programmable LCD panels. Masks are well known in lithography, and include mask types such as binary, alternating phase-shift, and attenuated phase-shift, as well as various hybrid mask types. An example of a programmable mirror array employs a matrix arrangement of small mirrors, each of which can be individually tilted so as to reflect an incoming radiation beam in different directions; in this manner, the reflected beam is patterned. In each example of patterning device, the support structure may be a frame or table, for example, which may be fixed or movable as may be needed, and which may ensure that the patterning device is at a desired position, for example, with respect to the projection system. Any use of the terms “reticle” or “mask” herein may be considered synonymous with the more general term “patterning device”.

The term “projection system” as used herein should be broadly interpreted as encompassing various types of projection system, including refractive optical systems, reflective optical systems, and catadioptric optical systems, as appropriate, for example, for the exposure radiation being used, or for other factors such as the use of an immersion fluid or the use of a vacuum. Any use of the term “lens” herein may be considered as synonymous with the more general term “projection system”.

The illumination system may also encompass various types of optical components, including refractive, reflective, and catadioptric optical components for directing, shaping, or controlling the projection beam of radiation, and such components may also be referred to below, collectively or singularly, as a “lens”.

The lithographic apparatus may be of a type having two (dual stage) or more substrate tables (and/or two or more mask tables). In such “multiple stage” machines the additional tables may be used in parallel, or preparatory steps may be carried out on one or more tables while one or more other tables are being used for exposure.

The lithographic apparatus may also be of a type wherein the substrate is immersed in a liquid having a relatively high refractive index, e.g. water, so as to fill a space between the final element of the projection system and the substrate. Immersion liquids may also be applied to other spaces in the lithographic apparatus, for example, between the mask and the first element of the projection system. Immersion techniques are well known in the art for increasing the numerical aperture of projection systems.

### BRIEF DESCRIPTION OF THE FIGURES

Embodiments of the invention will now be described, by way of example only, with reference to the accompanying schematic drawings in which corresponding reference symbols indicate corresponding parts, and in which:

FIG. 1 is a schematic of a lithographic apparatus according to an embodiment of the invention;

FIG. 2 is a schematic of a purge gas arrangement and associated control system of the apparatus of FIG. 1.

### DETAILED DESCRIPTION

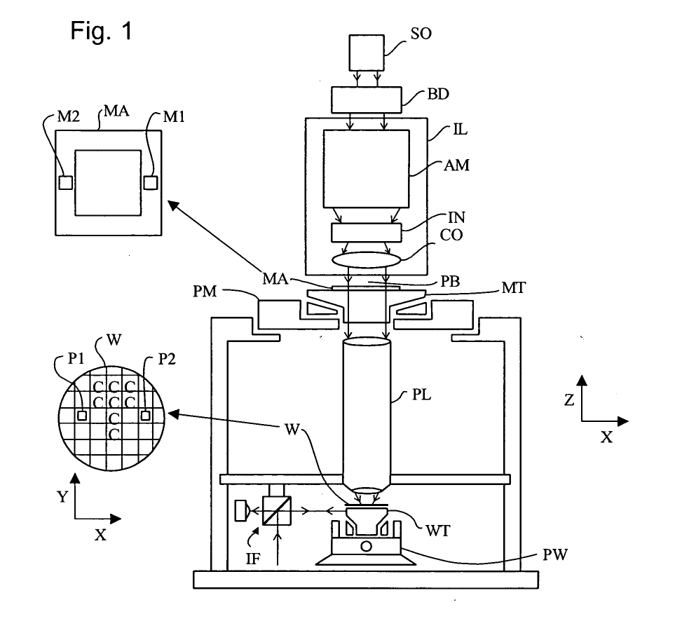

FIG. 1 schematically depicts a lithographic apparatus according to a particular embodiment of the invention. The apparatus includes: an illumination system (illuminator) IL for providing a projection beam PB of radiation (e.g. DUV radiation); a first support structure (e.g. a mask table) MT for supporting a patterning device (e.g. a mask) MA and connected to a first positioner PM for accurately positioning the patterning device with respect to item PL; a substrate table (e.g. a wafer table) WT for holding a substrate (e.g. a resist-coated wafer) W and connected to a second positioner PW for accurately positioning the substrate with respect to item PL; and a projection system (e.g. a refractive projection lens) PL for imaging a pattern imparted to the projection beam PB by the patterning device MA onto a target portion C (e.g. including one or more dies) of the substrate W.

As here depicted, the apparatus is of a transmissive type (e.g. employing a transmissive mask). Alternatively, the apparatus may be of a reflective type (e.g. employing a programmable mirror array of a type as referred to above).

The illuminator IL receives a beam of radiation from a radiation source SO. The source and the lithographic apparatus may be separate entities, for example, when the source is an excimer laser. In such cases, the source is not considered to form part of the lithographic apparatus and the radiation beam is passed from the source SO to the illuminator IL with the aid of a beam delivery system BD including, for example, suitable directing mirrors and/or a beam expander. In other cases the source may be integral part of the apparatus, for example, when the source is a mercury lamp. The source SO and the illuminator IL, together with the beam delivery system BD, if used, may be referred to as a radiation system.

The illuminator IL may include an adjusting device AM for adjusting the angular intensity distribution of the beam. Generally, at least the outer and/or inner radial extent (commonly referred to as σ-outer and σ-inner, respectively) of the intensity distribution in a pupil plane of the illuminator can be adjusted. In addition, the illuminator IL generally includes various other components, such as an integrator IN and a condenser CO. The illuminator provides a conditioned beam of radiation, referred to as the projection beam PB, having a desired uniformity and intensity distribution in its cross-section.

The projection beam PB is incident on the mask MA, which is held on the mask table MT. Having traversed the mask MA, the projection beam PB passes through the lens PL, which focuses the beam onto a target portion C of the substrate W. With the aid of the second positioner PW and position sensor IF (e.g. an interferometric device), the substrate table WT can be moved accurately, e.g. so as to position different target portions C in the path of the beam PB. Similarly, the first positioner PM and another position sensor (which is not explicitly depicted in FIG. 1) can be used to accurately position the mask MA with respect to the path of the beam PB, e.g. after mechanical retrieval from a mask library, or during a scan. In general, movement of the object tables MT and WT will be realized with the aid of a long-stroke module (coarse positioning) and a short-stroke module (fine positioning), which form part of the positioners PM and PW. However, in the case of a stepper (as opposed to a scanner) the mask table MT may be connected to a short stroke actuator only, or may be fixed. Mask MA and substrate W may be aligned using mask alignment marks M1, M2 and substrate alignment marks P1, P2.

The depicted apparatus may be used in the following example modes:
1. In step mode, the mask table MT and the substrate table WT are kept essentially stationary, while an entire pattern imparted to the projection beam is projected onto a target portion C in one go (i.e. a single static exposure). The substrate table WT is then shifted in the X and/or Y direction so that a different target portion C can be exposed. In step mode, the maximum size of the exposure field limits the size of the target portion C imaged in a single static exposure.

2. In scan mode, the mask table MT and the substrate table WT are scanned synchronously while a pattern imparted to the projection beam is projected onto a target portion C (i.e. a single dynamic exposure). The velocity and direction of the substrate table WT relative to the mask table MT is determined by the (de-)magnification and image reversal characteristics of the projection system PL. In scan mode, the maximum size of the exposure field limits the width (in the non-scanning direction) of the target portion in a single dynamic exposure, whereas the length of the scanning motion determines the height (in the scanning direction) of the target portion.

3. In another mode, the mask table MT is kept essentially stationary holding a programmable patterning device, and the substrate table WT is moved or scanned while a pattern imparted to the projection beam is projected onto a target portion C. In this mode, generally a pulsed radiation source is employed and the programmable patterning device is updated as needed after each movement of the substrate table WT or in between successive radiation pulses during a scan. This mode of operation can be readily applied to maskless lithography that utilizes programmable patterning devices, such as a programmable mirror array of a type as referred to above.

Combinations and/or variations on the above described modes of use or entirely different modes of use may also be employed.

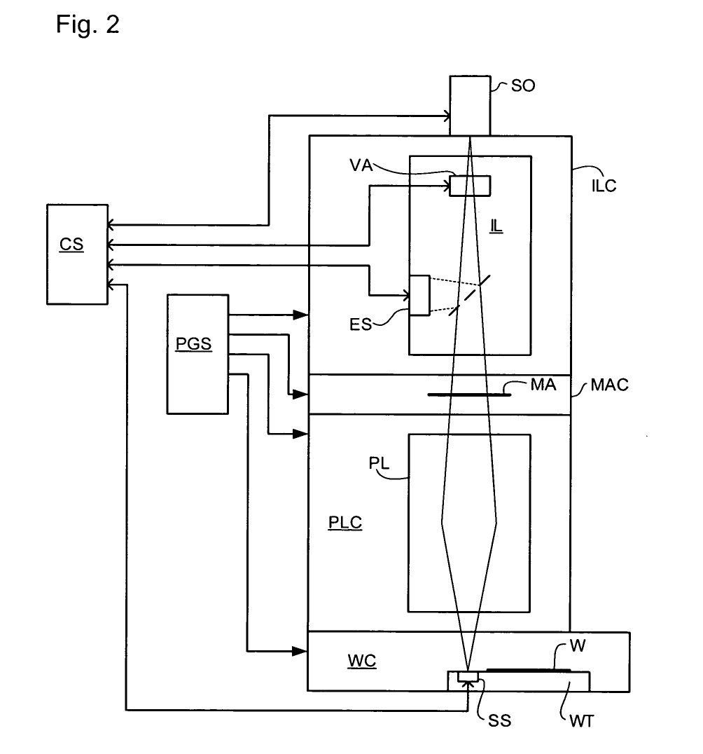

The purge gas arrangements of the apparatus and associated control system are shown in FIG. 2. The apparatus is divided in to a number of compartments, in this case four are shown—the illumination system compartment ILC, the mask compartment MAC, the projection system compartment PLC and the substrate compartment WC. To each compartment, purge gas is supplied from purge gas supply system PGS. In the case of an apparatus using exposure radiation of a wavelength of about 157 nm, the purge gas may be extremely pure N₂ to displace the air from the beam path, which would otherwise block the transmission of the exposure radiation.

The purge gas supply system PGS, or purge device, operates in two modes, a high-flow mode for the exposure of substrates, and a low-flow mode that is used when a compartment of the apparatus is open and/or during other down time of the apparatus. The low-flow mode consumes less of the purge gas, which is expensive due to its high purity, and is less hazardous to humans. Nevertheless, the flow is sufficient to protect the optical elements from contamination and prevent a build-up of contaminants in the apparatus. The actual flow rates in the high- and low-flow modes will depend on the sizes of the various compartments, as well as the leaks and other possible contamination sources within them. The flow rate in high-flow mode is generally three to four times that in low-flow mode. This factor may vary from apparatus to apparatus and from compartment to compartment. If not all compartments are to be opened, the compartments remaining closed may remain in high-flow mode.

After having operated in the low-flow mode for a period of time, it should be ensured that the contaminant levels in the beam path have returned to specified levels before exposures can begin, lest the optical elements in the projection and illumination systems be damaged by a reaction with a contaminant under the influence of the powerful projection beam.

When the high-flow mode is resumed, the control system CS, or controller, controls the radiation source SO to emit a low power beam and monitors the beam intensity at substrate level using a spot sensor SS built into the substrate table WT. When the measured intensity indicates a return to a normal transmission level, production exposures using a full power projection beam may resume. Because the transmission of the atmosphere in the beam path may be extremely sensitive to the contaminants that can damage the optical elements, principally oxygen and water vapor, the transmission returning to normal indicates that the beam path is contaminant free. Contamination of only 1-10 ppm may cause a distinct drop in transmission.

Various criteria may be used to determine whether the transmission is at normal levels, including but not limited to: the absolute intensity exceeding a threshold; the rate of change of intensity falling below a threshold; the uniformity of intensity across the cross-section of the projection beam exceeding a threshold, e.g. non-uniformity <0.2%; and the stability of the intensity over time exceeding a threshold, e.g. a variation <5%, preferably <2%, and most preferably <1%.

In all of the above criteria, time averages of the relevant parameters may be employed.

Where the source SO is a pulsed source, e.g. an excimer laser, the intensity of the projection beam may be reduced by reducing the pulse repetition rate, e.g. to <10 Hz, preferably about 1 Hz compared to a normal rate for exposures of 4 kHz or more. The intensity of the projection beam may also be controlled using a variable attenuator VA in the illumination system IL.

If the illumination system incorporates an energy sensor ES to which a proportion of the projection beam is directed, e.g. by a partly silvered mirror, the output of the energy sensor ES may also be taken into account, e.g. as a reference to enable variations in the source output to be compensated for. Also, if the only compartment which has been in the low-flow mode is up-beam of the energy sensor ES, the beam intensity measured by the energy sensor ES may be used in place of the intensity measured by the spot sensor SS.

While specific embodiments of the invention have been described above, it will be appreciated that the invention may be practiced otherwise than as described. The description is not intended to limit the invention.

1. A lithographic apparatus comprising:
an illumination system for transmitting a beam of radiation;
a support for supporting a patterning device, the patterning device serving to impart the beam of radiation with a pattern in its cross-section;
a substrate table for holding a substrate;
a projection system for projecting the patterned beam of radiation onto a target portion of the substrate;
a purging device for purging a part of the apparatus with a purge gas, the purging device being operable in a first mode having a relatively high flow of purge gas and a second mode having a relatively low flow of purge gas;
a sensor for measuring the intensity of said beam of radiation at a position downstream, with respect to the direction of the beam of radiation, of said part of said apparatus that is purged; and
a controller constructed and arranged to control an intensity of said beam of radiation, so that the intensity of the beam of radiation can be made lower than a normal intensity in response to a change in mode of said purging device from said second mode to said first mode, said controller being arranged to monitor the downstream intensity of said beam of radiation as measured by said sensor and to prevent generation of radiation at the normal intensity until the downstream intensity of said beam of radiation meets a predetermined criterion.

2. An apparatus according to claim 1 wherein said predetermined criterion is that the downstream intensity of the beam of radiation has reached a level indicating that transmission of a beam path has returned to a production level.

3. An apparatus according to claim 1 wherein said predetermined criterion is that a rate of change of the downstream intensity of the beam of radiation has fallen below a predetermined threshold.

4. An apparatus according to claim 1, wherein said sensor is spatially sensitive and said predetermined criterion is that the downstream intensity of the beam of radiation across a part of its cross-section has a predetermined uniformity.

5. An apparatus according to claim 4, wherein said predetermined uniformity is greater than about 99.8%.

6. An apparatus according to claim 1, wherein said predetermined criterion is that a variation in stability of the downstream intensity of the beam of radiation over time is less than a predetermined threshold.

7. An apparatus according to claim 6, wherein the predetermined threshold is about 5%.

8. An apparatus according to claim 7, wherein the predetermined threshold is about 2%.

9. An apparatus according to claim 8, wherein the predetermined threshold is about 1%.

10. An apparatus according to claim 1, wherein said predetermined criterion is based upon a time average of the downstream intensity of the beam of radiation or the rate of change thereof.

11. An apparatus according to claim 1, wherein said illumination system provides a pulsed beam of radiation and said controller controls said illumination system to provide a pulsed beam having a lower pulse repetition rate than that used during production as said beam of radiation of lower than the normal intensity.

12. An apparatus according to claim 1, wherein said controller controls a variable attenuator in said illumination system to generate said beam of radiation of lower than the normal intensity.

13. An apparatus according to claim 1, wherein said beam of radiation of said lower than the normal intensity has an intensity of less than or equal to 1% of said normal intensity.

14. An apparatus according to claim 1, wherein said sensor is provided on said substrate table.

15. A device manufacturing method comprising:
purging a part of a beam path traversed by a beam of radiation with a purge gas at a first flow rate;
purging said part of the beam path with a purge gas at a second flow rate that is higher than said first flow rate;
directing a beam of radiation at a first intensity along said beam path during said purging with the purge gas at the second flow rate;
monitoring a transmission of said part of the beam path;
directing a beam of radiation at a second intensity that is higher than said first intensity along said beam path, after the transmission of said beam path meets a predetermined criterion;
patterning the beam of radiation at the second intensity; and
projecting the patterned beam of radiation onto a target portion of a substrate.

16. A method according to claim 15, wherein said predetermined criterion is that the transmission of said part of the beam path has increased to a production level.

17. A device manufactured according to the method of claim 15.

18. A device manufacturing method for a lithographic apparatus, the method comprising:
patterning a beam of radiation;
projecting the patterned beam of radiation onto a target portion of a substrate;
purging a part of the apparatus with a purging device, the purging device being operable in a first mode having a relatively high flow of purge gas and a second mode having a relatively low flow of purge gas;
measuring the intensity of the beam of radiation at a position downstream, with respect to the direction of the beam of radiation, of the part of the apparatus that is purged, with a sensor; and
controlling an intensity of the beam of radiation, so that the intensity of the beam of radiation can be made lower than a normal intensity in response to a change in mode of the purging device from the second mode to the first mode, the controller being arranged to monitor the downstream intensity of the beam of radiation as measured by the sensor and to prevent generation of radiation at the normal intensity until the downstream intensity of the beam of radiation meets a predetermined criterion.
